(19) United States
(12) Patent Application Publication
(10) Pub. No.: US 2004/0226992 A1
(43) Pub. Date: Nov. 18, 2004

(54) System and method for transaction permission/rejection judgment

(75) Inventor: Shinya Imanishi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/803,251

(22) Filed: Mar. 17, 2004

(30) Foreign Application Priority Data
May 16, 2003 (JP) 2003-138504

(51) Int. Cl. G06F 17/60

(52) U.S. Cl. 235/379

(57) ABSTRACT

A user 106 who attempts to use a card 101 inputs a personal identification number, and first permission/rejection judgment is carried out using the number. If the result of the first permission/rejection judgment is affirmative, a card-ready terminal 102 transmits some information to a card authenticating host 104. The transmitted information includes acquired user image data obtained by acquiring the image of the user 106 and the details of the transaction inputted by the user. The host 104 transmits specific data containing the acquired user image data and the details of the transaction to a predetermined terminal 105. Then, the host 104 waits for the input of approval/rejection information on whether to approve the transaction from the terminal 105. On receipt of approval/rejection information from the terminal 105, the host 104 carries out second permission/rejection judgment based on the contents of the approval/rejection information. If the result of the second permission/rejection judgment is affirmative, the host 104 causes the card-ready terminal 102 to permit the transaction.

### BACKGROUND OF THE INVENTION

The present invention relates to a technology for judging whether to permit a user-desired transaction using a computer, and in particularly to a system and a method for judging whether to permit a transaction, requested by a user using a card-type recording medium, such as cash card, at a card-ready terminal (e.g. ATM terminal), using a computer.

There are various systems for judging whether to permit user-desired transactions. One example is a system for judging whether to permit transactions requested by users who use a card-type recording medium, such as cash card and credit card (hereafter, simply referred to as “card”). A typical example of this type of system is those introduced in financial institutions. In such a system, a user inserts a card into an ATM (Automated Teller Machine) terminal. (This user will be hereafter referred to as “transacting user.”) The user is prompted to input the user's personal identification number, and it is judged whether the inputted personal identification number is valid. When the number is judged valid, the user is permitted to withdraw cash.

Cardholders have a concern about such system. One of their cares is that someone who pretends to be the user may conduct illegal transactions. If a card for use in transactions is fraudulently used, for example, the cardholder becomes aware of the fraud only after the fraud has been carried out. The cardholder notices the fraud when he/she receives a statement of usage details from a card company. Or, the cardholder discovers the fraud when he/she realizes the loss of the card and makes an inquiry with the card company. To prevent such card fraud from occurring, the following card payment/transaction system has been proposed: when a transacting user uses a card, the user transmits electronic mail stating the details of the transaction the transacting user desires to a information processing terminal (e.g. cellular phone or personal computer) registered beforehand. Then, a user at the information processing terminal judges whether to approve the details of the transaction stated in the electronic mail. (This user will be hereafter referred to as “approving user.”) (Refer to the 73rd paragraph of Patent Document 1: Japanese Patent Prepublication No. 2002-133100, for example.) More specifically, in this system, two transaction permission/rejection judgments are carried out: first transaction permission/rejection judgment for checking the validity of an inputted personal identification number and determining whether to permit the transaction based on the result of the checking, and second transaction permission/rejection judgment for the approving user to judge whether to approve the transaction.

In the above-mentioned card payment/transaction system, the approving user can learn the details of transactions (e.g. amount of purchase, transaction value, outstanding balance, amount paid) from the contents of electronic mail. However, the approving user cannot grasp further information, such as who the transacting user is. Therefore, the approving user can have difficulty in judging whether to approve a transaction sometimes.

Further, in the above-mentioned card payment/transaction system, whether to transmit electronic mail stating the details of transactions can be specified on a card-by-card basis. If the transmission of electronic mail is specified, electronic mail must be transmitted to the approving user's terminal without fail each time a transaction is conducted and the approving user must input information on whether to approve the transaction. If this second permission/rejection judgment is carried out without exception, for example, the time for which ATM terminals are occupied by individual transacting users is unnecessarily lengthened. This will probably lengthen the time for which transacting users wait to use ATM terminals as well.

Further, in the above-mentioned card payment/transaction system, a transacting user cannot use his/her card to start a transaction until electronic mail is transmitted to the approving user's terminal and the transaction is approved by the approving user. This poses a problem. In some cases, transacting users cannot conduct a transaction for some reason, such as no response being made from the approving user, even though the transaction is not card fraud.

These problems arise not only in transactions using a card but also in transactions in other ways.

### SUMMARY OF THE INVENTION

An object of the present invention is to, if a transaction by a transacting user is permitted or rejected based on whether the transaction is approved, make it easy to determine whether to approve the transaction.

Another object of the present invention is to make it possible to select as appropriate whether either or both of first transaction permission/rejection judgment and second transaction permission/rejection judgment should be carried out before the judgments are made.

Another object of the present invention is to allow a user to conduct a desired transaction without approval from a predetermined information processing terminal as long as the transaction is not fraud.

To attain the above objects, a transaction permission/rejection judgment system according to a first aspect of the present invention (hereafter, referred to as “first system”) comprises a picked-up image inputting means; a first permission/rejection judging means; a second permission/rejection judging means; and a permitting means. When a user desires to conduct a transaction, the picked-up image inputting means is fed with picked-up user image data obtained by picking up the image of the user. The first permission/rejection judging means receives information for first permission/rejection judgment (e.g. password) for carrying out first permission/rejection judgment on whether to permit the user-desired transaction, inputted by the user. Then, using the information for first permission/rejection judgment, the first permission/rejection judging means carries out the first permission/rejection judgment. (For example, the first permission/rejection judging means judges the validity of the information for first permission/rejection judgment.) The second permission/rejection judging means transmits specific data to a predetermined information processing terminal through a communication network. The specific data contains the inputted picked-up user image data and the details of the user-desired transaction. Thus, the second permission/rejection judging means makes it possible to input approval/rejection information on whether to approve the transaction at the predetermined information processing terminal. On receipt of the approval/rejection information from the predetermined information processing terminal, the second permission/rejection judging means carries out the following processing: the second permission/rejection judging means carries out second permission/rejection judgment on whether to approve the user-desired transaction based on the contents of the received approval/rejection information. (For example, if the contents of approval/rejection information is affirmative, the second permission/rejection judging means outputs an affirmative result as second permission/rejection judgment.) If the result of at least the second permission/rejection judgment is affirmative, the permitting means permits the user-desired transaction.

In this first system, whether to approve a transaction can be determined based on the photographic image of the user who requests the transaction.

In a first preferred embodiment, a permission/rejection judgment controlling means is further provided. The permission/rejection judgment controlling means carries out second judgment necessity judgment on whether the second permission/rejection judgment is required. (For example, the permission/rejection judgment controlling means is fed with information for necessity judgment for carrying out the judgment. Then, using the information for necessity judgment, the permission/rejection judgment controlling means carries out the second judgment necessity judgment). If the result of the judgment is affirmative, the permission/rejection judgment controlling means causes the second permission/rejection judging means to carry out the second permission/rejection judgment. At this time, the permitting means carries out the following processing case by case: in case the second permission/rejection judgment is carried out, the permitting means permits the user-desired transaction if the result of at least the second permission/rejection judgment is affirmative. In case the second permission/rejection judgment is not carried out, the permitting means permits the transaction if the result of the first permission/rejection judgment is affirmative.

A transaction permission/rejection judgment system according to a second aspect of the present invention (hereafter, referred to as “second system”) comprises a first permission/rejection judging means; a second permission/rejection judging means; a permission/rejection judgment controlling means; and a permitting means. The first permission/rejection judging means is fed with information for first permission/rejection judgment for carrying out first permission/rejection judgment on whether to permit a user-desired transaction. Then, using the information for first permission/rejection judgment, the first permission/rejection judging means carries out the first permission/rejection judgment. The second permission/rejection judging means is fed with information for second permission/rejection judgment for carrying out second permission/rejection judgment on whether to permit the user-desired transaction. Then, using the information for second permission/rejection judgment, the second permission/rejection judging means carries out the second permission/rejection judgment. The permission/rejection judgment controlling means carries out second judgment necessity judgment on whether the second permission/rejection judgment is required. (For example, the permission/rejection judgment controlling means is fed with information for necessity judgment for carrying out the judgment. Then, using the information for necessity judgment, the permission/rejection judgment controlling means carries out the second judgment necessity judgment.) If the result of the judgment is affirmative, the permission/rejection judgment controlling means causes the second permission/rejection judging means to carry out the second permission/rejection judgment. The permitting means carries out the following processing case by case: in case the second permission/rejection judgment is carried out, the permitting means permits the user-desired transaction if the result of at least the second permission/rejection judgment is affirmative. In case the second permission/rejection judgment is not carried out, the permitting means permits the transaction if the result of the first permission/rejection judgment is affirmative. For example, if the result of the first permission/rejection judgment is negative, the permission/rejection judgment controlling means judges that second permission/rejection judgment is required. (One of the negative results is a case where the password or personal identification number inputted by a user is invalid.)

In this second system, both the first and the second permission/rejection judgments are carried out only when second judgment is required.

In a second preferred embodiment, the second permission/rejection judging means transmits specific data, containing the details of the user-desired transaction, to a predetermined information processing terminal through a communication network. Thus, the second permission/rejection judging means makes it possible to input approval/rejection information on whether to approve the transaction at the predetermined information processing terminal. On receipt of the approval/rejection information from the predetermined information processing terminal, the second permission/rejection judging means carries out the following processing: the second permission/rejection judging means carries out second permission/rejection judgment on whether to permit the user-desired transaction based on the contents of the received approval/rejection information.

In a third preferred embodiment, the first preferred embodiment or the second system further comprises a waiving request information storing means and a second judgment waiving requesting means. The waiving request information storing means stores second judgment waiving request information for making a request not to carry out the second permission/rejection judgment. The second judgment waiving requesting means accepts the input of the second judgment waiving request information from the user. In this case; the permission/rejection judgment controlling means acquires the second judgment waiving request information from the waiving request information storing means. Using the acquired second judgment waiving request information and the inputted second judgment waiving request information, the permission/rejection judgment controlling means carries out the second judgment necessity judgment. (For example, if the acquired second judgment waiving request information and the inputted second judgment waiving request information are matched with each other, the following takes place: the permission/rejection judgment controlling means outputs “second judgment not required” information as the result of the second judgment necessity judgment.)

At this time, the waiving request information storing means may be a means contained in the card-type recording medium in the possession of the user. Or, it may be a means (e.g. database) contained in a device which has at least any one of the first permission/rejection judging means, second permission/rejection judging means, permission/rejection judgment controlling means, and permitting means. (The examples of such a device include a card-ready terminal or a host device to be described later.)

The second judgment waiving request information stored in the waiving request information storing means need not always be identical with the second judgment waiving request information inputted by the user. For example, the second judgment waiving request information inputted by the user may be information obtained by subjecting the stored second judgment waiving request information to predetermined processing (e.g. encryption).

In a fourth preferred embodiment, the first preferred embodiment further comprises a user image storing means which stores user image data derived from the user's picture. The permission/rejection judgment controlling means acquires the user image data from the user image storing means. Then, using the acquired user image data and the picked-up user image data inputted through the picked-up image inputting means, the permission/rejection judgment controlling means carries out the second judgment necessity judgment. (As an example, it is assumed that a comparison between user image data and picked-up user image data reveals complete or substantial agreement therebetween. In this case, the permission/rejection judgment controlling means outputs “second judgment not required” information as the result of the second judgment necessity judgment.)

The user image storing means can be constituted in various ways. For example, it may be a means contained in the card-type recording medium in the possession of the user. Or, it may be a means (e.g. database) contained in a device which has at least any one of the first permission/rejection judging means, second permission/rejection judging means, permission/rejection judgment controlling means, and permitting means. (The example of such a device includes a card-ready terminal or a host device to be described later.)

In a fifth preferred embodiment, the predetermined information processing terminal in the first system or the second preferred embodiment is at least one of the following terminals:

(1) a portable or stationary terminal used by the user,

(2) a portable or stationary terminal used by someone other than the user specified beforehand by the user, and

(3) a terminal in the possession of a predetermined certification organization.

In a sixth preferred embodiment, the first system or the second preferred embodiment further comprises a destination of transmission storing means. The destination of transmission storing means stores a plurality of information processing terminals to which the specific data can be transmitted. The second permission/rejection judging means transmits the specific data to all the information processing terminals stored in the destination of transmission storing means. Then, the second permission/rejection judging means receives a plurality of pieces of approval/rejection information from a plurality of the information processing terminals. If all the pieces of the approval/rejection information are affirmative, the second permission/rejection judging means outputs an affirmative result as the result of the second permission/rejection judgment.

In a seventh preferred embodiment, the first system or the second preferred embodiment further comprises a destination of transmission storing means. The destination of transmission storing means stores a plurality of information processing terminals to which the specific data can be transmitted. The second permission/rejection judging means selects a first information processing terminal from among a plurality of the information processing terminals stored in the destination of transmission storing means. Then, the second permission/rejection judging means transmits the specific data to the first information processing terminal. If a predetermined communication error occurs or if the approval/rejection information is not transmitted from the predetermined information processing terminal in a certain time, the following takes place: the second permission/rejection judging means selects a second information processing terminal from among a plurality of the information processing terminals. Then, the second permission/rejection judging means transmits the specific data to the second information processing terminal.

In this embodiment, the destination of transmission storing means may further store the priorities of a plurality of the information processing terminals. In this case, for example, the second permission/rejection judging means can selects an information processing terminal as a destination of transmission based on the priorities. Then, the second permission/rejection judging means can transmit the specific data to that information processing terminal for approval.

In an eighth preferred embodiment, the first system further comprises a transaction request receiving means and a user image pick-up means. The transaction request receiving means functions to receive requests for the user-desired transaction from the user. It is a device provided, for example, with a user interface function. The user image pick-up means picks up the image of the user who requests the transaction through the transaction request receiving means. Then, the user image pick-up means creates picked-up user image data and outputs the picked-up user image data. The user image pick-up means is, for example, a cellular phone itself, a card-ready terminal itself, or a camera device installed in proximity thereto. (An example of the camera device is a digital camera which takes moving pictures or freeze-frame pictures.) In this embodiment, data inputted by the picked-up image inputting means is user image data outputted from the user image pick-up means.

In a ninth preferred embodiment, the transaction in the first or second system is that conducted using a card-type recording medium on which predetermined information is stored. More specifically, the card-type recording medium is, for example, IC card, magnetic card, or the like, such as credit card or cash card.

In a tenth preferred embodiment, the transaction request receiving means in the ninth preferred embodiment further comprises a card inserting means and a card reading means. The card inserting means is for inserting the card-type recording medium, and the card reading means reads predetermined information out of the card-type recording medium as is inserted into the card inserting means. The user image pick-up means is a picture taking device installed in proximity to the transaction request receiving means. In this case, the first permission/rejection judging means receives the information for first permission/rejection judgment inputted by the user. Then, using the inputted information for first permission/rejection judgment and the predetermined information readout of the card-type recording medium, the first permission/rejection judging means carries out the first permission/rejection judgment.

In an eleventh preferred embodiment, the ninth preferred embodiment comprises a means which performs at least one of the following processing if approval/rejection information received from the predetermined information processing terminal is negative:

(1) processing of bringing the card-type recording medium into invalid state so that a transaction using the card-type recording medium cannot be conducted thereafter,

(2) processing comprising a step of transmitting a plurality of card status options to the predetermined information processing terminal for selecting into what state the card-type recording medium should be brought; and a step of, if one or more card status options are selected from a plurality of the card status options at the predetermined information processing terminal, bringing the card-type recording medium into the state corresponding to the one or more card status options selected; and

(3) processing of informing a specific device of a possibility of an abuse of the card-type recording medium. (The specific device is, for example, a predetermined device located in the card company of the card-type recording medium or an organization related thereto.)

The above-mentioned first system performs, for example, the operation comprising the following steps:

(A) a step in which if a user requests a transaction, a computer (e.g. host device) is fed with picked-up user image data, obtained by picking up the image of the user, from a predetermined terminal (e.g. camera device), and stores the data in memory;

(B) a step in which a computer (e.g. a transaction request receiving terminal, such as a card-ready terminal, or a host device communicatably connected thereto) is fed with information for first permission/rejection judgment, inputted by the user, for carrying out first permission/rejection judgment on whether to permit the user-desired transaction, stores the information in memory, and carries out the first permission/rejection judgment using the information for first permission/rejection judgment;

(C) a step in which a computer (e.g. a transaction request receiving terminal, such as a card-ready terminal, or a host device communicatably connected thereto) transmits specific data containing the inputted picked-up user image data and the details of the user-desired transaction to a predetermined information processing terminal through a communication network, makes it possible to input approval/rejection information on whether to approve the transaction at the predetermined information processing terminal, and on receipt of the approval/rejection information from the predetermined information processing terminal, temporarily stores the received approval/rejection information in memory, and further carries out second permission/rejection judgment on whether to permit the user-desired transaction based on the contents of the approval/rejection information; and

(D) a step in which if the result of at least the second permission/rejection judgment is affirmative, a computer (e.g. a transaction request receiving terminal, such as a card-ready terminal, or a host device communicatably connected thereto) permits the user-desired transaction.

The above-mentioned second system performs, for example, the operation comprising the following steps:

(a) a step in which a computer (e.g. a transaction request receiving terminal, such as a card-ready terminal, or a host device communicatably connected thereto) is fed with information for first permission/rejection judgment for carrying out first permission/rejection judgment on whether to permit a user-desired transaction, stores the information in memory, and carries out the first permission/rejection judgment using the information for first permission/rejection judgment;

(b) a step in which a computer (e.g. a transaction request receiving terminal, such as a card-ready terminal, or a host device communicatably connected thereto) is fed with information for second permission/rejection judgment for carrying out second permission/rejection judgment on whether to permit the user-desired transaction, stores the information in memory, and carries out the second permission/rejection judgment using the information for second permission/rejection judgment;

(c) a step in which a computer (e.g. a transaction request receiving terminal, such as a card-ready terminal, or a host device communicatably connected thereto) carries out second judgment necessity judgment on whether the second permission/rejection judgment is required, and if the result of the judgment is affirmative, carries out the second permission/rejection judgment; and

(d) a step in which a computer (e.g. a transaction request receiving terminal, such as a card-ready terminal, or a host device communicatably connected thereto) carries out the following processing case by base: in case the second permission/rejection judgment is carried out, the computer permits the user-desired transaction if the result of at least the second permission/rejection judgment is affirmative. In case the second permission/rejection judgment is not carried out, the computer permits the transaction if the result of the first permission/rejection judgment is affirmative.

A third system according to the present invention is a system for carrying out permission/rejection judgment on whether to permit a user-desired transaction. The third system comprises a picked-up image inputting means which if a user desires a transaction, is fed with picked-up user image data created by picking up the image of the user; a permission/rejection judging means which transmits specific data, containing the inputted picked-up user image data and the details of the user-desired transaction, to a predetermined information processing terminal through a communication network, makes it possible to input approval/rejection information on whether to approve the transaction at the predetermined information processing terminal, and on receipt of the approval/rejection information from the predetermined information processing terminal, carries out permission/rejection judgment on whether to permit the user-desired transaction based on the received approval/rejection information; and a permitting means which if the result of the permission/rejection judgment is affirmative, permits the user-desired transaction.

The user terminal according to the present invention is a user terminal which can be used to carry out permission/rejection judgment on whether to permit a user-desired transaction. The user terminal comprises a receiving means which if a user desires a transaction, receives specific data containing picked-up user image data created by picking up the image of the user and the contents of the user-desired transaction through a communication network; a displaying means which displays the picked-up user image data and the details of the transaction contained in the received specific data and further makes it possible for the user to input approval/rejection information on whether to approve the transaction; and a transmitting means which when the approval/rejection information is inputted by the user, transmits the inputted approval/rejection information to a predetermined terminal device.

The above specific data contains, for example, an approving tool for inputting a judgment of approval or rejection. (An example of the approving tool is a button group including an approval button representing an intention of approval and a rejection button representing an intention of rejection.) In this case, the displaying means displays the approving tool together with the picked-up user image data and the details of the transaction. If approval/rejection information on whether to approve a transaction is inputted using the approving tool, the transmitting means transmits the inputted approval/rejection information to a predetermined terminal device. (Examples of the predetermined terminal device include the origin of transmission of the specific data and a predetermined destination of transmission described in the specific data.)

Each of the means in the first to third systems according to the present invention can be implemented by a computer. A computer program therefor can be installed on or loaded into the computer through various media, including a disk-type storage, semiconductor memory, and communication network.

In at least one of the first to third systems according to the present invention, for example, a plurality of the means may be provided in one device or distributedly provided in a plurality of devices.

### BRIEF DESCRIPTION OF THE DRAWINGS

FIG. 1 is a block diagram illustrating an example of the system configuration of a card use authorization system to which an embodiment of the present invention is applied.

FIG. 2 is a block diagram illustrating an example of the card-ready terminal 102 and the camera device 103.

FIG. 3 is a block diagram illustrating an example of a card authenticating host 104.

FIG. 4 illustrates an example of information stored in the database of a card information data unit 403.

FIG. 5 is a block diagram illustrating an example of a transaction approving terminal 105.

FIG. 6 is a drawing illustrating the general flow of the operation by the card use authorization system in the embodiments.

FIG. 7 is a flowchart of the sequence of processing by the card-ready terminal 102.

FIG. 8 is a flowchart of the sequence of processing by the card authenticating host 104.

FIG. 9 is a flowchart of the sequence of processing by the transaction requesting terminal 105.

FIG. 10 is a drawing illustrating the flow of operation which takes place when input indicating rejection is done on the transaction approving terminal 105 in a first modification to the embodiments.

FIG. 11 is a drawing illustrating the flow of operation the card authenticating host 104 performs on receipt of “rejected” information from the transaction approving terminal 105 in the first modification to the embodiments.

### DESCRIPTION OF THE PREFERRED EMBODIMENTS

Referring to the drawings, the embodiments of the present invention will be described below.

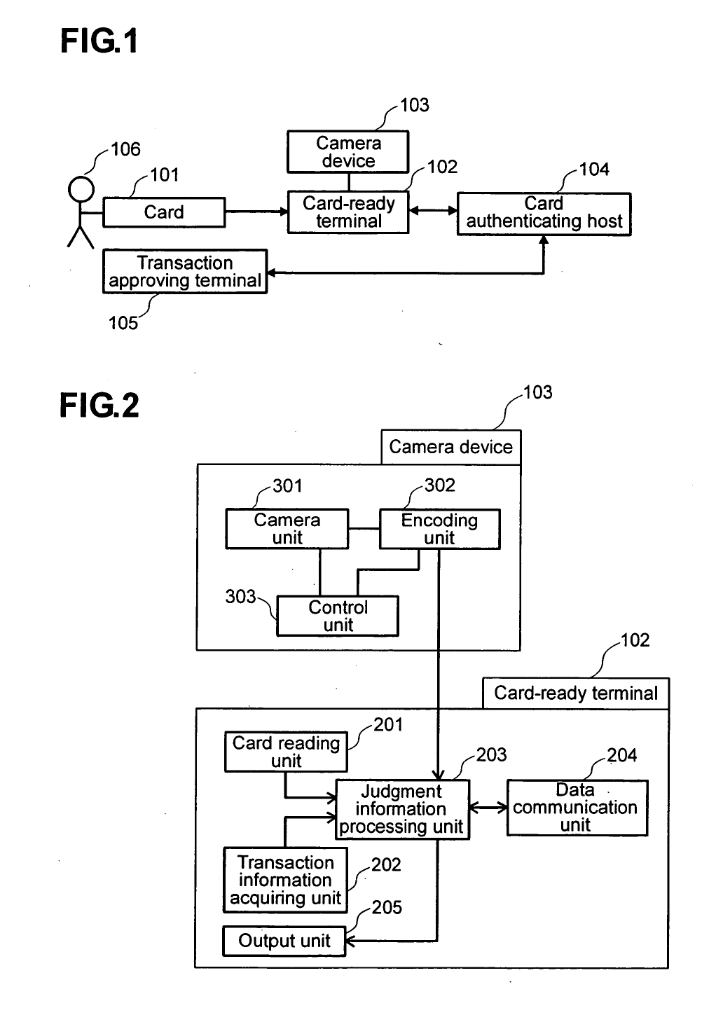

FIG. 1 illustrates an example of the system configuration of a card use authorization system to which an embodiment of the present invention is applied.

This system is capable of carrying out two types of judgment (hereafter, referred to as “transaction permission/rejection judgment”) on whether to permit a transaction requested by a user using a card-type recording medium with predetermined card information stored thereon. (The card-type recording medium will be hereafter simply referred to as “card.”) The system is so constituted that it judges whether to permit a user-desired transaction based on the result of the transaction permission/rejection judgment. (Hereafter, a first transaction permission/rejection judgment will be referred to as “first judgment,” and a second transaction permission/rejection judgment will be referred to as “second judgment.”) Specific description will be given below.

This system comprises devices marked with reference numbers 101 to 105.

Reference number 101 represents a card on which predetermined card information (e.g. card ID and/or user ID and personal identification number) is recorded. The card 101 is, for example, an IC card, a magnetic card, or the like, and is used by a user 106 to conduct a predetermined transaction, such as cash withdrawal. (The user who conducts a transaction will be hereafter referred to as “transacting user.”)

Reference number 102 represents a card-ready terminal capable of reading out card information recorded on the card 101. Examples of the card-ready terminal include ATM terminals and CAT terminals installed in banks, convenience stores, and the like. When a transaction (e.g. cash withdrawal) is requested by the transacting user 106, the card-ready terminal 102 accepts the input of the personal identification number of the card 101 and a second judgment waiving password. The second judgment waiving password is for instructing the system to waive second judgment. Further, the card-ready terminal 102 transmits information inputted by the transacting user 106 to a card authenticating host 104 to be described later. (The above information contains at least the personal identification number. The inputted information will be hereafter referred to as “transaction permission request information.”) The card-ready terminal 102 is capable of also transmitting other information to the card authenticating host 104. Such information includes card information read out of the card 101, the details of the transaction requested by the transacting user 106, and picked-up user image data inputted through the camera device 103 to be described later. On receipt of information indicating the result of various judgments from the card authenticating host 104, the card-ready terminal 102 determines whether to execute the transaction requested by the transacting user 106 based on the information. These information include information indicating the result of first judgment (hereafter, referred to as “first judgment result information”) and information indicating the result of second judgment (hereafter, referred to as “second judgment result information”).

Reference number 103 represents a camera device which is installed on or near the card-ready terminal 102 and is for picking up the image of transacting users 106 who use the card-ready terminal 102. The camera device 103 picks up the image of the transacting user 106 using the card-ready terminal 102 with predetermined timing. At the same time, the camera device 103 creates picked-up user image data derived from the transacting user 106's picture, and inputs the picked-up user image data to the card-ready terminal 102. An example of the above “predetermined timing” is time when it is detected that the card 101 is inserted into the card-ready terminal 102. Another example is time when after permission is allowed as the result of first judgment, the details of the desired transaction are inputted by the transacting user 106. The picked-up user image data may be moving picture image data or freeze-frame picture image data.

Reference number 104 represents a card authenticating host communicatably connected with the card-ready terminal 102. The card authenticating host 104 is a host computer which judges whether to permit a transaction requested by the transacting user 106 at the card-ready terminal 102. More specifically, for example, the card authenticating host 104 carries out first judgment using a personal identification number inputted by the transacting user 106 and card information read out of the card 101. Then, the card authenticating host 104 outputs first judgment result information indicating the result of the judgment to the card-ready terminal 102. Further, the card authenticating host 104 judges the validity of a second judgment waiving password inputted by the transacting user 106. (This judgment carried out by the card authenticating host 104 will be hereafter referred to as “second judgment necessity judgment.”) Then, the card authenticating host 104 also outputs information indicating the result of the judgment (hereafter, referred to “necessity judgment result information”) to the card-ready terminal 102. On receipt of picked-up user image data and transaction details information from the card-ready terminal 102, the card authenticating host 104 outputs specific data to the transaction approving terminal 105. (The specific data contains the picked-up user image data and the transaction details information, and will be hereafter referred to as “approval request data.”) On receipt of approval request result information indicating whether to approve the transaction from the transaction approving terminal 105, the card authenticating host 104 carries out second judgment using the approval request result information. Then, the card authenticating host 104 outputs second judgment result information indicating the result of the judgment to the card-ready terminal 102.

The number of card-ready terminals 102 connectable to one card authenticating host 104 may be one, as illustrated in the figure, or more.

Reference number 105 represents a transaction approving terminal which receives approval request data from the card authenticating host 104 and makes it possible to input information indicating whether to approve the user-desired transaction in response thereto. The transaction approving terminal 105 is a communication terminal, such as cellular phone, PDA, or personal computer, used by the transacting user 106 himself/herself or a predetermined third person (e.g. someone specified beforehand by the holder of the card 101). When fed with a determination to approve or reject a user-desired transaction, the transaction approving terminal 105 transmits information indicating the determination to the user authenticating host 104 through a communication network. (This information will be hereafter referred to as “transaction approval/rejection information.”)

The above-mentioned card-ready terminal 102, camera device 103, card authenticating host 104, and transaction approving terminal 105 will be described in detail below.

FIG. 2 is a block diagram illustrating an example of the card-ready terminal 102 and camera device 103.

The card-ready terminal 102 comprises a card reading unit 201, a transaction information acquiring unit 202, a judgment information processing unit 203, a data communication unit 204, and an output unit 205. The card-ready terminal 102 further comprises a memory, such as RAM, and CPU though these constituent members are not shown. The memory is used to temporarily store information when the information is passed within the card-ready terminal 102 and on other like occasions. The CPU is used when the judgment information processing unit 203 or the like performs processing.

The card reading unit 201 receives the card 101 inserted, reads card information recorded on the card 101, and inputs the card information to the judgment information processing unit 203.

The transaction information acquiring unit 202 has, for example, a user input unit (e.g. touch panel-type display unit) for accepting varied information inputted by the transacting user 106. On receipt of predetermined information inputted by the transacting user 106, the transaction information acquiring unit 202 inputs the inputted information to the judgment information processing unit 203. (The above predetermined information is, for example, personal identification number and the details of a transaction.)

The judgment information processing unit 203 accepts transaction permission request information and the details of a transaction inputted by the transacting user 106 through the transaction information acquiring unit 202. (The transaction permission request information is a personal identification number or it and a second judgment waiving password.) On receipt of the input of card information from the card reading unit 201, the judgment information processing unit 203 transmits some information to the card authenticating host 104 through the data communication unit 204. The transmitted information includes the inputted card information and the transaction permission request information inputted by the transacting user 106 through the transaction information acquiring unit 202. The judgment information processing unit 203 also transmits other information to the card authenticating host 104 through the data communication unit 204. The other transmitted information includes picked-up user image data acquired from the encoding unit 302 (to be described later) of the camera device 103 and transaction details information inputted by the transacting user 106 through the transaction information acquiring unit 202. Further, the judgment information processing unit 203 receives first judgment result information and second judgment result information from the card authenticating host 104 through the data communication unit 204. Then, the judgment information processing unit 203 determines whether to permit the user-desired transaction based on the contents of the information. More specifically, the judgment information processing unit 203 controls, for example, the operation of the output unit 205.

The data communication unit 204 is a communication interface to the card authenticating host 104. The data communication unit 204 transmits information from the judgment information processing unit 203 to the card authenticating host 104. Further, it inputs information from the card authenticating host 104 to the judgment information processing unit 203.

The output unit 205 has, for example, a cash inlet/outlet portion where paper money and coins are put in or discharged and a screen (e.g. touch panel-type display unit) for displaying the contents of first judgment result information and second judgment result information. Under the control of the judgment information processing unit 203, the output unit 205 dispenses a sum of money requested by users and displays the contents of first judgment result information and second judgment result information.

The camera device 103 comprises a camera unit 301, the encoding unit 302, and a control unit 303.

The camera unit 301 picks up the image of a transacting user 106 who uses the card-ready terminal 102 and acquires the above-mentioned picked-up user image data.

The encoding unit 302 encodes picked-up user image data created by the camera unit 301, and transmits the encoded image data to the judgment information processing unit 203 of the card-ready terminal 102 by air or by wire.

The control unit 303 controls the operation of the camera unit 301 and the encoding unit 302 of the camera device 103.

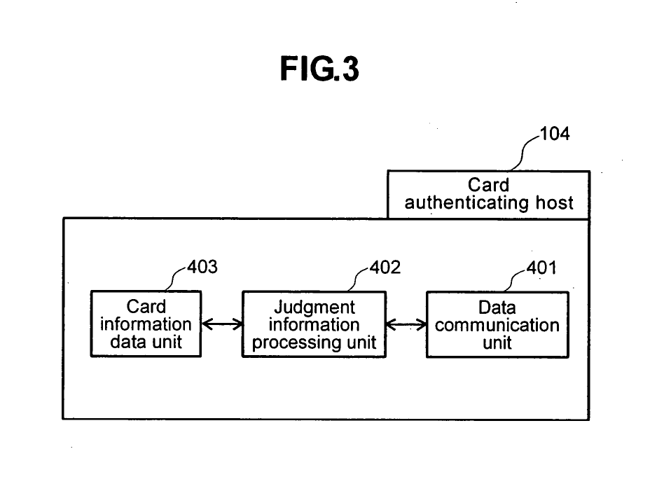

FIG. 3 is a block diagram illustrating an example of the card authenticating host 104.

The card authenticating host 104 comprises a data communication unit 401, a judgment information processing unit 402, and a card information data unit 403. The card authenticating host 104 also comprises a memory, such as RAM, and CPU though these constituent members are not shown. The memory is used to temporarily store information when the information is passed within the card authenticating host 104 and on other like occasions. The CPU is used when the judgment information processing unit 402 or the like performs processing.

The data communication unit 401 is a communication interface for communication with the card-ready terminal 102 or the transaction approving terminal 105. The data communication unit 401 transmits information from the judgment information processing unit 402 to the card-ready terminal 102 or the transaction approving terminal 105. Further, the data communication unit 401 inputs information from the card-ready terminal 102 or the transaction approving terminal 105 to the judgment information processing unit 402.

The judgment information processing unit 402 carries out first judgment and second judgment necessity judgment using transaction permission request information received from the card-ready terminal 102. Further, the judgment information processing unit 402 carries out second judgment using transaction approval/rejection information received from the transaction approving terminal 105 through the data communication unit 204. (The details of first judgment, second judgment, and second judgment necessity judgment will be specifically described later.) In second judgment necessity judgment, the judgment information processing unit 402 refers to the data in the card information data unit 403.

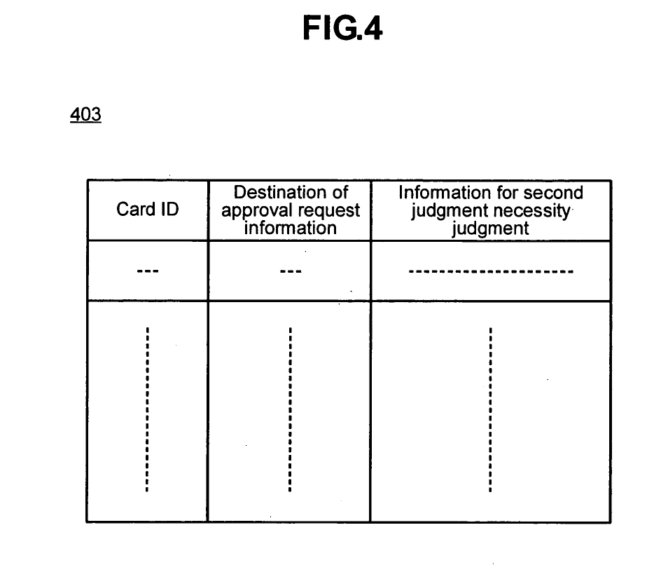

The card information data unit 403 comprises a storage device (e.g. memory) for temporarily storing card information inputted through the data communication unit 401; and a database (not shown) which stores information illustrated as an example in FIG. 4. Varied information is stored beforehand in the database. As illustrated in FIG. 4, the information includes a plurality of card IDs (or the user IDs of card holders), a plurality of pieces of destination of approval request information and information for second judgment necessity judgment which respectively correspond to a plurality of the card IDs.

The destination of approval request information is information representing one or more transaction approving terminals 105 to which approval request data (that is, data containing picked-up user image data and transaction details information) is to be transmitted. An example of the destination of approval request information is electronic mail address. The destination of approval request information is registered beforehand by predetermined persons (e.g. card holders).

The information for second judgment necessity judgment is information which is used in second judgment necessity judgment. More specifically, it is, for example, information to be used for checking the validity of a second judgment waiving password which is inputted by the transacting user 106 when second judgment is not required. (The processing carried out using these information will be specifically described later.)

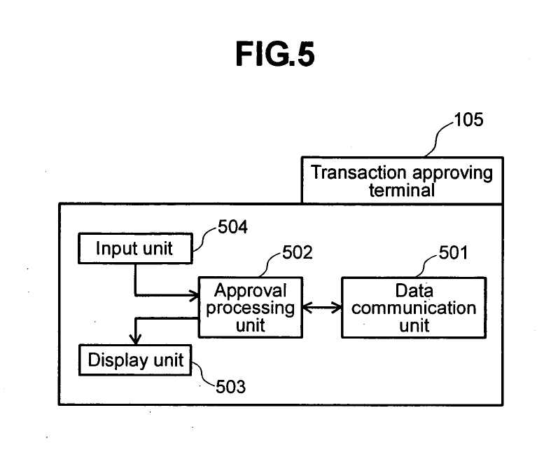

FIG. 5 is a block diagram illustrating an example of the transaction approving terminal 105.

The transaction approving terminal 105 comprises a data communication unit 501, an approval processing unit 502, a display unit 503 having a display screen, and an input unit 504 for inputting desired information through key operation. The transaction approving terminal 105 also comprises a memory, such as RAM, and CPU though these constituent members are not shown. The memory is used to temporarily store information when the information is passed within the transaction approving terminal 105 and on other like occasions. The CPU is used when the approval processing unit 502 or the like performs processing.

The data communication unit 501 is a communication interface capable of communicating with the card authenticating host 104. The data communication unit 501 inputs information received from the card authenticating host 104 to the approval processing unit 502. Further, the data communication unit 501 transmits information inputted from the approval processing unit 502 to the card authenticating host 104.

The approval processing unit 502 displays approval request data, inputted from the card authenticating host 104 through the data communication unit 501, on the display unit 503. (The approval request data is data containing transaction details information and picked-up user image data.) In response thereto, the approval processing unit 502 operates as follows: a determination to approve or reject the transaction is inputted by the user of this terminal 105 (hereafter, referred to as “approving user”) through the input unit 504. Then, the approval processing unit 502 transmits approval/rejection information indicating the determination to the card authenticating host 104 through the data communication unit 501.

The above is the description of the card-ready terminal 102, camera device 103, card authenticating host 104, and transaction approving terminal 105.

Next, the general flow of operation of the card use authorization system in the embodiments will be described. Thereafter, the sequence of processing by each of the card-ready terminal 102, card authenticating host 104, and transaction approving terminal 105 will be described.

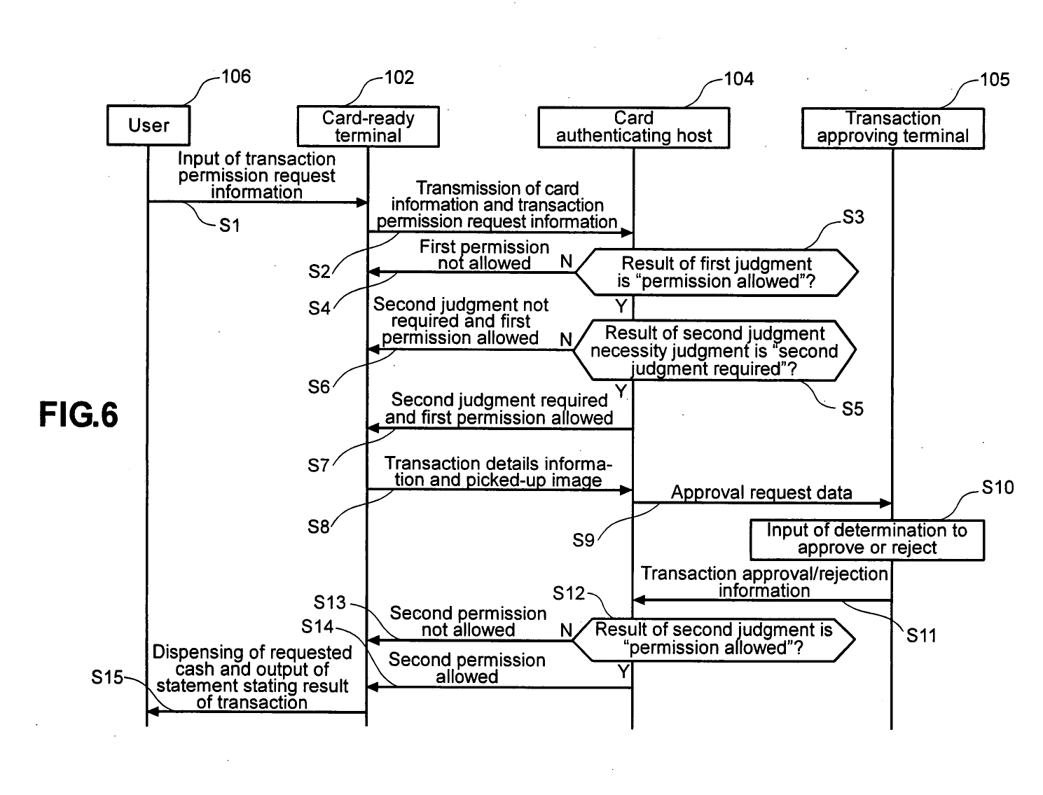

FIG. 6 is a drawing illustrating the general flow of operation of the card use authorization system in the embodiments.

First, the transacting user 106 inserts the card 101 in the possession of himself/herself into the card reading unit 201 of the card-ready terminal 102. Then, the card-ready terminal 102 accepts the input of transaction permission request information through the transaction information acquiring unit 202 (e.g. touch panel-type display screen). (The transaction permission request information is a personal identification number and a second judgment waiving password).

When the transaction permission request information (at least a personal identification number) is inputted by the transacting user 106 (Step 1), the card-ready terminal 102 reads card information out of the card 101 using the card reading unit 201. Then, the card-ready terminal 102 transmits the card information and the transaction permission request information inputted at Step 1 to the card authenticating host 104 (Step 2).

On receipt of the card information and the transaction permission request information, the card authenticating host 104 temporarily stores these information in the recording device (e.g. memory) of the card information data unit 403. Then, the card authenticating host 104 checks the validity of the personal identification number contained in the transaction permission request information (hereafter, referred to as “user-inputted personal identification number”). This is first judgment. At this time, the card authenticating host 104 uses the personal identification number contained in the card information (hereafter, referred to as “card personal identification number”). More specifically, for example, the card authenticating host 104 judges the agreement between the card personal identification number and the user-inputted personal identification number and thereby carries out first judgment (Step 3).

If the result of the judgment reveals that the card personal identification number is not matched with the user-inputted personal identification number (N at Step 3), the card authenticating host 104 transmits some information to the card-ready terminal 102 (Step 4). This information indicates that the result of the first judgment is negative. (This information will be hereafter referred to as “first permission not allowed.”) In this case, for example, the card-ready terminal 102 informs the user 106 that the transaction is unacceptable (by, for example, display on the display screen). Thereafter, the card-ready terminal 102 can execute predetermined processing, such as accepting the reentry of the personal identification number.

If the result of the processing at Step 3 reveals that the card personal identification number is matched with the user-inputted personal identification number (Y at Step 3), the card authenticating host 104 carries out second judgment necessity judgment.

More specifically, the card authenticating host 104 checks first whether a second judgment waiving password is contained in the transaction permission request information inputted by the user 106. If the result of the check reveals that a second judgment waiving password is contained therein, the card authenticating host 104 performs the following processing: it acquires information for second judgment necessity judgment corresponding to the card ID contained in the card information stored in the storage device of the card information data unit 403 from the database of the card information data unit 403. Then, the card authenticating host 104 checks the validity of the second judgment waiving password inputted by the user 106, using the acquired information for second judgment necessity judgment. This is second judgment necessity judgment. More specifically, for example, the card authenticating host 104 judges the agreement between the information for second judgment necessity judgment and the second judgment waiving password (Step 5).

If the result of the processing at Step 5 reveals that the information for second judgment necessity judgment is matched with the second judgment waiving password (N at Step 5), the following takes place: in this case, the password is valid, and there is no harm in waiving second judgment. Therefore, the card authenticating host 104 transmits some information to the card-ready terminal 102 (Step 6). The transmitted information includes information indicating that second judgment is unnecessary (hereafter, referred to as “second judgment not required”) and information indicating that the result of the first judgment at Step 3 is affirmative (hereafter, referred to as “first permission allowed”). In this case, for example, the card-ready terminal 102 accepts the details of the transaction (e.g. a sum of money to be withdrawn) inputted by the user, and executes the transaction corresponding to the contents of the inputted information.

If the result of the processing at Step 5 reveals that a second judgment waiving password is not contained in the transaction permission request information (Y at Step 5), second judgment is required. Also, if the information for second judgment necessity judgment is not matched with the second judgment waiving password (Y at Step 5), second judgment is required. Therefore, the card authenticating host 104 transmits some information to the card-ready terminal 102 (Step 7). The transmitted information includes information indicating that second judgment is necessary (hereafter, referred to as “second judgment required”) and “first permission allowed.”

On receipt of “first permission allowed” plus “second judgment required” from the card authenticating host 104, the card-ready terminal 102 inputs a control signal to the camera device 103. The card-ready terminal 102 thereby causes the camera device 103 to pick up the image of the user 106, and acquires picked-up user image data derived from the user 106's picture form the camera device 103. Further, the card-ready terminal 102 accepts the details of the transaction (e.g. a sum of money to be withdrawn) inputted by the user. On receipt of the details of the transaction from the user, the card-ready terminal 102 transmits some information to the card authenticating host 104 (Step 8). The transmitted information includes transaction details information representing the details of the transaction and the picked-up user image data acquired from the camera device 103.

On receipt of the transaction details information and the picked-up user image data from the card-ready terminal 102, the card authenticating host 104 performs the following processing: it acquires destination of approval request information corresponding to the card ID contained in the card information stored in the storage device of the card information data unit 403. Thereafter, the card authenticating host 104 creates approval request data. The approval request data contains the received transaction details information and information for second judgment necessity judgment and an approving tool for inputting a determination to approve or reject the transaction described in the transaction details information. (An example of the approving tool is buttons which are a graphical user interface and contains an approval button and a rejection button.) Then, the card authenticating host 104 transmits the created approval request data to a predetermined transaction approving terminal 105 specified by the acquired destination of approval request information by, for example, electronic mail (Step 9).

On receipt of the approval request data from the card authenticating host 104, the transaction approving terminal 105 performs the following processing: it displays the transaction details information, picked-up user image data, and approving tool contained in the approval request data, and accepts the input of a determination to approve or reject the transaction. If a determination to approve or reject the transaction is inputted using the approving tool (for example, if either the approval button or the rejection button is pressed (Step 10), the transaction approving terminal 105 performs the following processing: it transmits transaction approval/rejection information indicating approval or rejection to the card authenticating host 104 by, for example, electronic mail (Step 11).

On receipt of the transaction approval/rejection information, the card authenticating host 104 performs the following processing: it identifies the origin of transmission of the received transaction approval/rejection information from a predetermined code (e.g. the electronic mail address of the origin of transmission) contained in the information. At the same time, the card authenticating host 104 identifies the card-ready terminal 102 wherein the card whose destination of approval request is matched with the identified origin of transmission is inserted. Then, the card authenticating host 104 judges whether the received transaction approval/rejection information is information indicating approval (hereafter, referred to as “approved”) or information indicating rejection (hereafter, referred to as “rejected”). Based on the result of the judgment, the card authenticating host 104 carries out second judgment. As an example, more specific description will be given. If the received transaction approval/rejection information is “rejected” (N at Step 12), the card authenticating host 104 transmits some information to the identified card-ready terminal 102 as the result of the second judgment (Step 13). This information indicates a negative result (and will be hereafter referred to as “second permission not allowed”). In this case, for example, the card-ready terminal 102 informs the user 106 that the transaction is unacceptable (by, for example, display on the display screen). Thereafter, the card-ready terminal 102 can execute predetermined processing, such as informing a predetermined device (e.g. a terminal in a predetermined financial institution) of the possibility of card fraud.

If the received transaction approval/rejection information is “approved” (Y at Step 12), the card authenticating host 104 transmits some information to the identified card-ready terminal 102 as the result of the second judgment (Step 14). The transmitted information indicates an affirmative result (and will be hereafter referred to as “second permission allowed”). In this case, the card-ready terminal 102 executes the transaction whose details are inputted at Step 8. For example, the card-ready terminal 102 dispenses cash requested by the user 106 at Step 8, and outputs a statement stating the result of the transaction (Step 15).

The above is the description of the general flow of processing by the card use authorization system in the embodiments. Next, the sequence of processing by each of the card-ready terminal 102, card authenticating host 104, and transaction approving terminal 105 will be described.

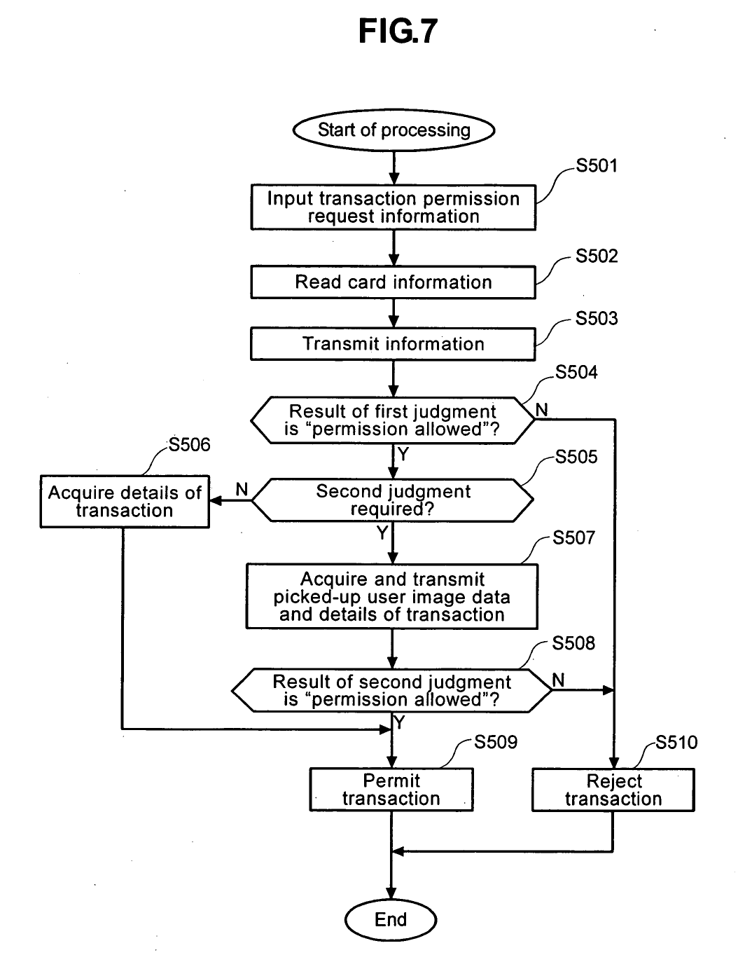

FIG. 7 is a flowchart of the sequence of processing by the card-ready terminal 102.

The card 101 is inserted into the card reading unit 201 of the card-ready terminal 102 by the transacting user 106. At the same time, a desired transaction (e.g. cash withdrawal) is requested by the transacting user 106. Then, the card-ready terminal 102 prompts the transacting user 106 to input some information through the transaction information acquiring unit 202 (Step 501). The inputted information is personal identification number and second judgment waiving password. (These information will be hereafter referred to as “transaction permission request information”.)

Thus, the transaction permission request information (at least personal identification number) is inputted by the transacting user 106 through the transaction information acquiring unit 202 (Step 501). Then, the card-ready terminal 102 reads card information out of the card 101 using the card reading unit 201 (Step 502). The card-ready terminal 102 transmits the card information and the transaction permission request information inputted at Step 1 to the card authenticating host 104 (Step 503).

Thereafter, the card-ready terminal 102 receives first judgment result information and second judgment necessity judgment result information.

If the card-ready terminal 102 receives “first permission not allowed” as first judgment result information (N at Step 504), it does not permit the user-desired transaction (e.g. cash withdrawal) (Step 510). More specifically, for example, the card-ready terminal 102 informs the user 106 that the transaction is unacceptable (by, for example, display on the display screen). Thereafter, the card-ready terminal 102 executes predetermined processing, such as accepting the reentry of the personal identification number.

Meanwhile, the card-ready terminal 102 can receive “first permission allowed” as first judgment result information and further “second judgment not required” as second judgment necessity judgment result information (N at Step 504 and N at Step 505). In this case, the card-ready terminal 102 accepts the details of the transaction (e.g. a sum of money to be withdrawn) inputted by the user 106 (Step 506), and executes the transaction whose details are inputted (Step 509).

Or, the card-ready terminal 102 can receive “first permission allowed” as first judgment result information and further “second judgment required” as second judgment necessity judgment result information (N at Step 504 and Y at Step 505). In this case, the card-ready terminal 102 inputs a control signal to the camera device 103, and thereby causes the camera device 103 to pick up the image of the user 106. Then, the card-ready terminal 102 acquires picked-up user image data derived from the user 106's picture from the camera device 103. Further, the card-ready terminal 102 accepts the details of the transaction (e.g. a sum of money to be withdrawn) inputted by the user 106. On receipt of the details of the transaction from the user, the card-ready terminal 102 transmits some information to the card authenticating host 104 (Step 507). The transmitted information includes transaction details information representing the details of the transaction and the picked-up user image data acquired from the camera device 103.

Thereafter, the card-ready terminal 102 receives second judgment result information from the card authenticating host 104. If the card-ready terminal 102 receives “second permission not allowed” as second judgment result information (N at Step 508), it does not permit the transaction requested by the user 106 at Step 507 (Step 510). If the card-ready terminal 102 receives “second permission allowed” (Y at Step 508), it permits the requested transaction (Step 509).

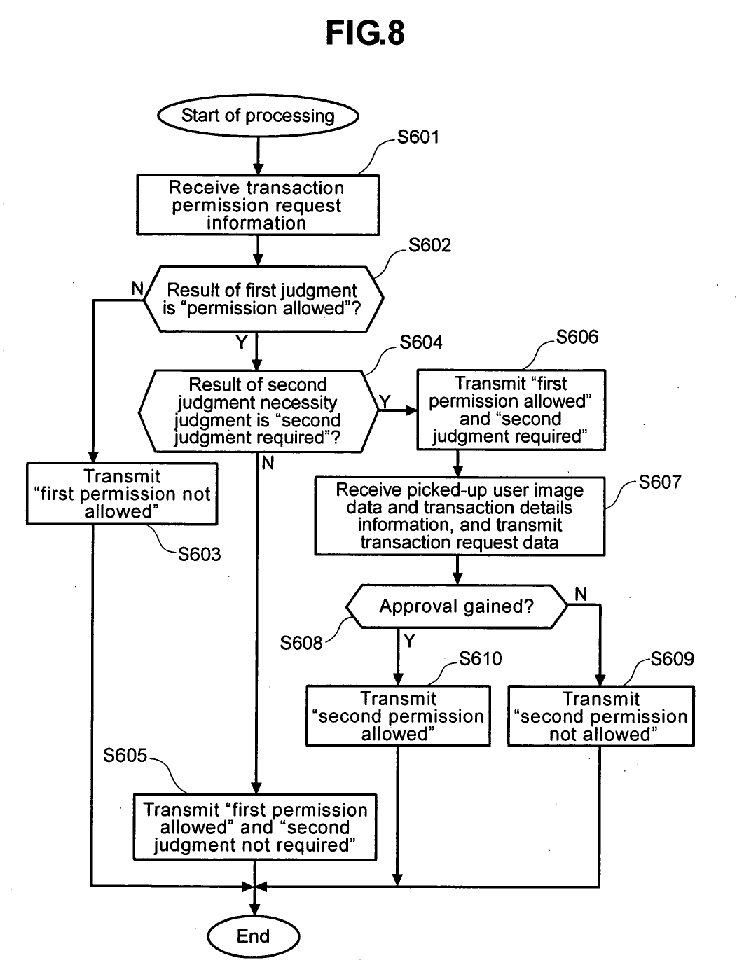

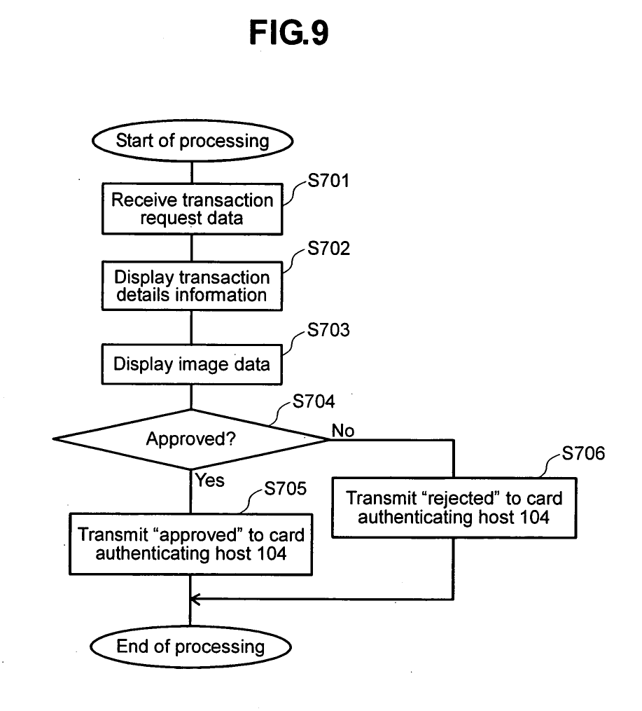

FIG. 8 is a flowchart of the sequence of processing by the card authenticating host 104.

The card authenticating host 104 receives the transaction permission request information inputted by the user 106 and the card information on the card 101 from the card-ready terminal 102 (Step 601). Then, the card authenticating host 104 temporarily stores these information in the recording device (e.g. memory) of the card information data unit 403. Thereafter, the card authenticating host 104 checks the validity of the user-inputted personal identification number using the above-mentioned card personal identification number. This is first judgment. More specifically, for example, the card authenticating host 104 judges the agreement between the card personal identification number and the user-inputted personal identification number, and thereby carries out first judgment (Step 602).

If the result of the judgment reveals that the card personal identification number is not matched with the user-inputted personal identification number (N at Step 602), the card authenticating host 104 transmits “first permission not allowed” to the card-ready terminal 102 (Step 603).

If the result of the judgment at Step 602 reveals that the card personal identification number is matched with the user-inputted personal identification number (Y at Step 3), the card authenticating host 104 carries out second judgment necessity judgment.

More specific description will be given. First, the card authenticating host 104 checks whether a second judgment waiving password is contained in the transaction permission request information inputted by the user 106. If the result of the check reveals that a second judgment waiving password is contained therein, the card authenticating host 104 acquires some information from the database of the card information data unit 403. The acquired information is information for second judgment necessity judgment corresponding to the card ID contained in the card information stored in the storage device of the card information data unit 403. Then, the card authenticating host 104 checks the validity of the second judgment waiving password inputted by the user 106, using the acquired information for second judgment necessity judgment. The card authenticating host 104 thereby carries out second judgment necessity judgment. More specifically, for example, the card authenticating host 104 judges the agreement between the information for second judgment necessity judgment and the second judgment waiving password (Step 604).

If the result of the judgment at Step 604 reveals that the information for second judgment necessity judgment is matched with the second judgment waiving password (N at Step 604), the following takes place: in this case, second judgment is unnecessary. Therefore, the card authenticating host 104 transmits “first permission allowed” plus “second judgment not required” to the card-ready terminal 102 (Step 605).

If the result of the judgment at Step 604 reveals that a second judgment waiving password is not contained in the transaction permission request information (Y at Step 604), second judgment is required. Also, if the information for second judgment necessity judgment is not matched with the second judgment waiving password (Y at Step 604), second judgment is required. Therefore, the card authenticating host 104 transmits “first permission allowed” plus “second judgment required” to the card-ready terminal 102 (Step 606).

On receipt of the transaction details information and the picked-up user image data from the card-ready terminal 102 after Step 606, the card authenticating host 104 carries out the following processing: it acquires destination of approval request information corresponding to the card ID contained in the card information stored in the storage device of the card information data unit 403. Then, the card authenticating host 104 creates approval request data. The approval request data contains the received transaction details information and information for second judgment necessity judgment and the above-mentioned approving tool. (The approving tool is a user interface containing, for example, an approval button and a rejection button.) Then, the card authenticating host 104 transmits the created approval request data to a predetermined transaction approving terminal 105 specified by the acquired destination of approval request information by, for example, electronic mail (Step 607).

When transaction approval/rejection information is thereafter sent back from the transaction approving terminal 105 as the destination of transmission of the approval request data, the card authenticating host 104 performs the following processing: it judges whether the transaction approval/rejection information is “approved” or “rejected.” Then, it carries out second judgment based on the result of the judgment (Step 608). More specific description will be given. If the received transaction approval/rejection information is “rejected” (N at Step 608), the card authenticating host 104 transmits “second permission not allowed” to the identified card-ready terminal 102 (Step 609). If the received transaction approval/rejection information is “approved” (Y at Step 608), the card authenticating host 104 transmits “second permission allowed” to the identified card-ready terminal 102 (Step 610).

FIG. 8 is a flowchart of the sequence of processing by the transaction requesting terminal 105.

On receipt of the approval request data from the card authenticating host 104 (Step 701), the transaction approving terminal 105 displays the transaction details information contained in the approval request data (Step 702). At the same time, the transaction approving terminal 105 displays the picked-up user image data and the approving tool (Step 703). Thereby, the transaction approving terminal 105 accepts the input of a determination to approve or reject the transaction.

If a determination to approve the transaction is inputted using the approving tool (for example, if the approval button is pressed) (Yes at Step 704), the transaction approving terminal 105 sends “approved” back to the card authenticating host 104 as the origin of transmission of the approval request data (Step 705). If a determination to reject the transaction is inputted using the approving tool (for example, if the rejection button is pressed) (No at Step 704), the transaction approving terminal 105 sends “rejected” back to the card authenticating host 104 (Step 706).

In the above-mentioned embodiments, the necessity of second judgment is judged by the card authenticating host 104, and second judgment is carried out only when it is judged to be necessary. If there is a high possibility of card fraud (for example, there is a possibility that a second judgment waiving password inputted by a user 106 is invalid), the card authenticating host 104 judges that second judgment is necessary. Then, second judgment is carried out. Thus, if it is evident that second judgment is unnecessary (for example, if the card holder is identical with the transacting user 106), second judgment is prevented from being carried out.

Further, in the above-mentioned embodiments, picked-up user image data derived from the picture of a user 106 who requests a transaction is created. The image data is transmitted to the transaction approving terminal 105 at which the approving user is and the image is displayed there. For this reason, the approving user can view the picture of the transacting user 106 who is trying to conduct a transaction to identify the user 106 before determining to approve or reject the transaction. This makes it easy for the approving user to determine to approve or reject a transaction. Further, this helps the approving user recognize someone vicious who is trying card fraud.

For example, the following modifications are possible to the above-mentioned embodiments.

(1) First Modification

The card authenticating host 104 transmits approval request data to the transaction approving terminal 105. At this time, a tool for specifying what action will be taken in rejection may be included in the approval request data. More specifically, this tool is that for selecting a desired one from among a plurality of options of rejecting action (hereafter, referred to as “rejecting action selecting tool”) An example of the rejecting action selecting tool is a screen display showing a plurality of options of rejecting action and radio buttons for selecting a desired one from among the options.

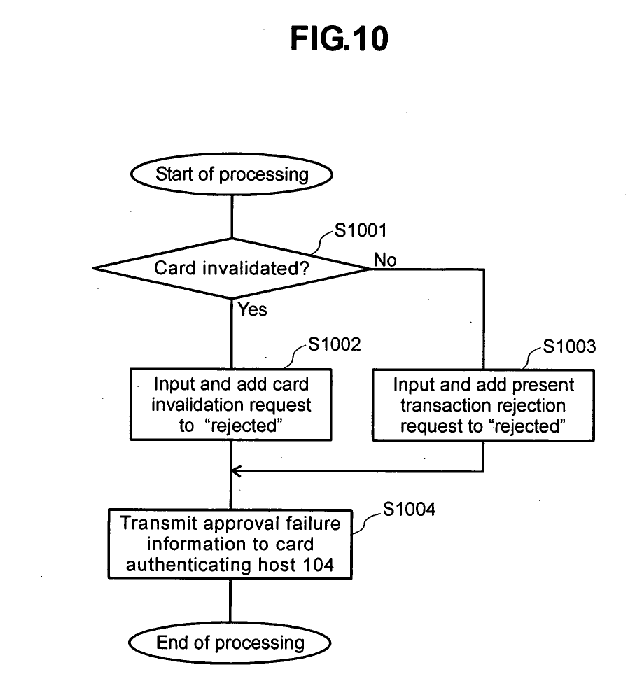

The transaction approving terminal 105 receives approval request data containing such a rejecting action selecting tool. If a determination to reject the transaction is thereafter inputted, the transaction approving terminal 105 displays the rejecting action selecting tool contained in the approval request data. There are various possible options of rejecting action selected using the rejecting action selecting tool. FIG. 10 illustrates two examples: “card invalidated” and “this transaction rejected.” In case of “card invalidated,” the card 101 concerned cannot be used from that time on. In case of “this transaction rejected,” only the present transaction is inhibited.

If “card invalidated” is selected by the approving user using the rejecting action selecting tool (Yes at Step 1001), the transaction approving terminal 105 creates “rejected” information containing data indicating that card invalidation is demanded. (This data will be hereafter referred to as “card invalidation data.”) Then, the transaction approving terminal 105 transmits the “rejected” information to the card authenticating host 104 (Step 1004).

If “this transaction rejected” is selected by the approving user using the rejecting action selecting tool (No at Step 1001), the transaction approving terminal 105 creates “rejected” information containing data indicating that only the present transaction is rejected. (This data will be hereafter referred to as “present transaction rejection data.”) Then, the transaction approving terminal 105 transmits the “rejected” information to the card authenticating host 104 (Step 1004).

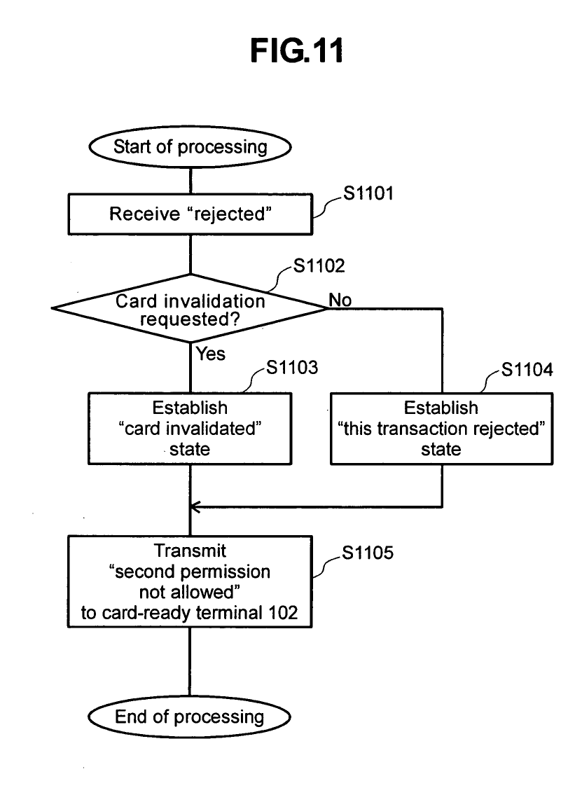

On receipt of “rejected” (Step 1101), the card authenticating host 104 examines whether card invalidation data or present transaction rejection data is contained in the “rejected” information as illustrated in FIG. 11 (Step 1102).

If card invalidation data is contained in “rejected,” the card authenticating host 104 sets the status of the card 101 inserted in the card-ready terminal 102 to invalid state (Step 1103). At the same time, the card authenticating host 104 transmits “second permission not allowed” to the card-ready terminal 102 (Step 1105). This operation will be more specifically described. For example, a valid/invalid flag corresponding to card IDs is provided in the above-mentioned database or the storage area in the card 101. “Set the status of the card 101 to invalid state” means that the card authenticating host 104 sets or causes the card-ready terminal 102 to set this valid/invalid flag.

If the result of the examination at Step 1102 reveals that present transaction rejection data is contained in “rejected,” the card authenticating host 104 sets the status of the present transaction to unapproved state (Step 1104). At the same time, the card authenticating host 104 transmits “second permission not allowed” to the card-ready terminal 102 (Step 1105). “Set the status of the present transaction to unapproved state” means, for example, rejecting the present transaction. Or, it means, in addition thereto, rejecting all the transactions requested at some point of time close to the time of the present transaction using the card 101 for which the present transaction is rejected. This can be done by setting a predetermined flag as in card invalidation.

According to the first modification, the approving user can select what action he/she should take to prevent card fraud case by case. More specific description will be given. If a complete stranger attempts to use the card, the approving user can invalidate the card. If a member of the approving user's family attempts to use the card 101, the approving user can reject only the requested transaction.

In the first modification, if “card invalidation data” is contained in “second permission not allowed” received by the card authenticating host 104, the status of the card 101 is set to invalid state. (This is done by, for example, correlating information indicating invalid state with a relevant card ID stored in the database of the card information data unit 403.) A constitution to cancel the invalid state may be adopted: the approving user accesses the card information data unit 403 of the card authenticating host 104 from the transaction approving terminal 105. Then, the approving user cancels the card information indicating invalid state.

(2) Second Modification

A plurality of transaction approving terminals 105 may be registered in a card authenticating host 104. If more than one transaction approving terminal 105 are registered, the card authenticating host 104 may transmit approval request data to all or some of the transaction approving terminals 105. Then, a transaction may be established only when “approved” is received from all or predetermined ones of the destinations of transmission of the data. There are various methods for determining to which ones of a plurality of transaction approving terminals 105 approval request data should be transmitted. For example, priorities can be set for the individual transaction approving terminals 105 and the destinations of transmission cay be selected according to the priorities.

(3) Third Modification

A plurality of transaction approving terminals 105 and the priorities of the transaction approving terminals 105 may be registered in the database of a card authenticating host 104 with respect to each card ID (or user ID). In this case, for example, the card authenticating host 104 transmits approval request data to the transaction approving terminal 105 of the highest priority. If communication connection cannot be established or there is no response in a certain time, the card authenticating host 104 may establish communication connection with the transaction approving terminal 105 of the next highest priority. Then, the card authenticating host 104 retransmits approval request data thereto. If it is detected that the transaction approving terminal 105 of the highest priority cannot communicate, the card authenticating host 104 may change the priority setting thereof with another transaction approving terminal 105. In this case, the priorities in approval request registered in the card information data unit 403 may be changed as follows: a transaction approving terminal 105 establishes communication connection to the card authenticating host 104, and then the priorities are changed through operation at the transaction approving terminal 105.

(4) Fourth Modification

The details of action taken when “first permission not allowed” or “second permission not allowed” is received may be registered beforehand in the database of the card authenticating host 104. (Examples of such action include setting the status of the card 101 to invalid state, and rejecting only the present transaction.) Then, if “first permission not allowed” or “second permission not allowed” is obtained at the card authenticating host 104, action may be taken based on the previously registered details of action.

(5) Fifth Modification

In the above-mentioned embodiments, if the result of first judgment is negative, the card authenticating host 104 transmits “first permission not allowed.” The following alternative constitution may be adopted: picked-up user image data is inputted to the card authenticating host 104 from the camera device 103 through the card-ready terminal 102. Then, the card authenticating host 104 transmits the picked-up user image data plus some tool to the transaction approving terminal 105. The transmitted tool is an approving tool for inputting a determination to approve or reject a transaction requested by the user embraced in a picture from which the picked-up user image data is derived. If a determination to approve the transaction is inputted by the approving user using the approving tool, the card authenticating host 104 accepts the input of the details of the transaction through the card-ready terminal 102. Thus, even if the transacting user 106 has forgotten his/her personal identification number, he/she can conduct a desired transaction. Since a transaction is not carried out without approval from the approving user, there is no possibility that an illegal transaction is carried out.

(6) Sixth Modification

In place of or in addition to the presence or absence of second judgment waiving password, the card authenticating host 104 can carry out second judgment by the method described below:

User information data obtained beforehand by picking up the image of the user is stored in the database of the card authenticating host 104 or the storage area of the card 101. When the card authenticating host 104 acquires picked-up user image data, it compares the picked-up user image data with the previously stored user image data. The card authenticating host 104 thereby judges the agreement between the subjects of the photographs in the image data. If the result of the comparison reveals substantial agreement, the card authenticating host 104 outputs “second judgment not required.” If the subjects of the photographs are not substantially matched with each other, the card authenticating host 104 outputs “second judgment required.”

(7) Seventh Modification

In the above-embodiments, a second judgment waiving password is inputted. Instead, the card authenticating host 104 may judge second judgment to be necessary if the result of first judgment is negative.

Up to this point, preferred embodiments of the present invention and several modifications thereto have been described. They are merely examples of the present invention, and the scope thereof is not limited to these embodiments or modifications. The present invention can be embodied in other various manners. For example, the present invention is applicable not only to transactions using a card but also to other transactions.

What is claimed is:

1. A transaction permission/rejection judgment system for carrying out permission/rejection judgment on whether to permit a user-desired transaction, the system comprising:
an acquired image inputting means which when a user desires a transaction, inputs acquired user image data obtained from an image of the user;
a first permission/rejection judging means which receives information for carrying out a first permission/rejection judgment on whether to permit the user-desired transaction, inputted by the user;
a second permission/rejection judging means which transmits data containing the user image data and information about the user-desired transaction to a predetermined information processing terminal through a communication network, and on receipt of approval/rejection information from the predetermined information processing terminal, carries out a second permission/rejection judgment on whether to permit the user-desired transaction based on the contents of the received approval/rejection information; and
a permitting means which if the result of the second permission/rejection judgment is affirmative, permits the user-desired transaction.

2. The system according to claim 1, further comprising:
a permission/rejection judgment controlling means which determines whether the second permission/rejection judgment is required, and if the result is affirmative, causes the second permission/rejection judging means to carry out the second permission/rejection judgment,
wherein the permitting means permits the user-desired transaction if the result of at least the second permission/rejection judgment is affirmative when the second permission/rejection judgment is carried out, and permits the transaction if the result of the first permission/rejection judgment is affirmative when the second permission/rejection judgment is not carried out.

3. The system according to claim 2, further comprising:
a waiving request information storing means which stores second judgment waiving request information for requesting a waiver of the second permission/rejection judgment; and
a second judgment waiving requesting means which accepts the second judgment waiving request information inputted by the user,
wherein the permission/rejection judgment controlling means acquires the second judgment waiving request information from the waiving request information storing means, and carries out the second judgment necessity judgment using the acquired second judgment waiving request information and the inputted second judgment waiving request information.

4. The system according to claim 2, further comprising:
a user image storing means which stores user image data derived from the user's picture,
wherein the permission/rejection judgment controlling means acquires the user image data from the user image storing means, and carries out the second judgment necessity judgment using the acquired user image data and the acquired user image data inputted by the acquired image inputting means.

5. The system according to claim 1,
wherein the predetermined information processing terminal is at least one of the following terminals:
(1) a portable or stationary terminal used by the user;
(2) a portable or stationary terminal used by someone other than the user specified beforehand by the user; and
(3) a terminal in the possession of a predetermined certification organization.

6. The system according to claim 1, further comprising:
a transmission storing means which stores a plurality of information processing terminals to which the specific data can be transmitted,
wherein the second permission/rejection judging means transmits data to all of a plurality of the information processing terminals stored in the transmission storing means, receives a plurality of pieces of approval/rejection information from a plurality of the information processing terminals, and if the approval/rejection information is all affirmative, outputs an affirmative result as the result of the second permission/rejection judgment.

7. The system according to claim 1, further comprising:
a transmission storing means which stores a plurality of information processing terminals to which the specific data can be transmitted,
wherein the second permission/rejection judging means selects a first information processing terminal from among a plurality of the information processing terminals stored in the destination of transmission storing means, transmits data to the first information processing terminal, selects a second information processing terminal from among a plurality of the information processing terminals if a predetermined communication error occurs or the approval/rejection information is not transmitted from the predetermined information processing terminal in a certain time, and transmits data to the second information processing terminal.

8. The system according to claim 1, further comprising:
a transaction request receiving means which accepts a request for the user-desired transaction from the user; and
a user image acquiring means which acquires the image of the user who requests the transaction, and outputs the acquired user image data,
wherein data inputted by the acquired image inputting means is user image data outputted from the user image acquiring means.

9. The system according to claim 1, wherein the transaction is a transaction carried out using a card-type recording medium with predetermined information stored therein.

10. The system according to claim 9,
wherein the transaction request receiving means comprises a card inserting means for receiving the card-type recording medium and a card reading means which reads the predetermined information out of the card-type recording medium as is inserted into the card inserting means,
wherein the user image acquiring means is a picture taking device installed in proximity to the transaction request receiving means,
wherein the first permission/rejection judging means accepts information for first permission/rejection judgment inputted by the user, and carries out the first permission/rejection judgment using the inputted information for first permission/rejection judgment and predetermined information read out of the card-type recording medium.

11. The system according to claim 9, comprising:
a system which if approval/rejection information received from the predetermined information processing terminal is negative, performs at least one of the following processing:
(1) processing of bringing the card-type recording medium into invalid state so that a transaction using the card-type recording medium cannot be conducted thereafter,
(2) processing comprising a step of transmitting a plurality of card status options to the predetermined information processing terminal for selecting into which state the card-type recording medium should be brought; and a step of, if one or more card status options are selected from a plurality of the card status options at the predetermined information processing terminal, bringing the card-type recording medium into the state corresponding to the one or more card status options selected; and
(3) processing of informing a specific device of a possibility of an abuse of the card-type recording medium.

12. A transaction permission/rejection judgment method for carrying out permission/rejection judgment on whether to permit a user-desired transaction, the method comprising:
a step of, if a user desires a transaction, inputting acquired user image data obtained by acquiring the image of the user;
a step of accepting information for first permission/rejection judgment for carrying out first permission/rejection judgment on whether to permit the user-desired transaction, inputted by the user, and carrying out the first permission/rejection judgment using the information for first permission/rejection judgment;
a step of transmitting specific data containing the inputted acquired user image data and the details of the user-desired transaction to a predetermined information processing terminal through a communication network, making it possible to input approval/rejection information on whether to approve the transaction at the predetermined information processing terminal, and on receipt of the approval/rejection information from the predetermined information processing terminal, carrying out second permission/rejection judgment on whether to permit the user-desired transaction based on the received approval/rejection information; and
a step of permitting the user-desired transaction if the result of at least the second permission/rejection judgment is affirmative.

13. A transaction permission/rejection judgment method for carrying out permission/rejection judgment on whether to permit a user-desired transaction, the method comprising:
a step of inputting information for first permission/rejection judgment for carrying out first permission/rejection judgment on whether to permit a user-desired transaction, and carrying out the first permission/rejection judgment using the information for first permission/rejection judgment;
a step of inputting information for second permission/rejection judgment for carrying out second permission/rejection judgment on whether to permit the user-desired transaction, and carrying out the second permission/rejection judgment using the information for second permission/rejection judgment;
a step of carrying out second judgment necessity judgment on whether the second permission/rejection judgment is required, and if the result of the judgment is affirmative, carrying out the second permission/rejection judgment; and
a step of permitting the user-desired transaction if the result of at least the second permission/rejection judgment is affirmative when the second permission/rejection judgment is carried out, and permitting the transaction if the result of the first permission/rejection judgment is affirmative when the second permission/rejection judgment is not carried out.

14. A transaction permission/rejection judgment system for carrying out permission/rejection judgment on whether to permit a user-desired transaction, the system comprising:
an acquired image inputting means which if a user desires a transaction, inputs acquired user image data obtained by acquiring the image of the user;
a permission/rejection judging means which transmits specific data containing the inputted acquired user image data and the details of the user-desired transaction to a predetermined information processing terminal through a communication network, makes it possible to input approval/rejection information on whether to approve the transaction at the predetermined information processing terminal, and on receipt of the approval/rejection information from the predetermined information processing terminal, carries out permission/rejection judgment on whether to permit the user-desired transaction based on the contents of the received approval/rejection information; and
a permitting means which permits the user-desired transaction if the result of the permission/rejection judgment is affirmative.

15. A transaction permission/rejection judgment method for carrying out permission/rejection judgment on whether to permit a user-desired transaction, the method comprising:
a step of, if a user desires a transaction, inputting acquired user image data obtained by acquiring the image of the user;
a step of transmitting specific data containing the inputted acquired user image data and the details of the user-desired transaction to a predetermined information processing terminal through a communication network, making it possible to input approval/rejection information on whether to approve the transaction at the predetermined information processing terminal, and on receipt of the approval/rejection information from the predetermined information processing terminal, carrying out permission/rejection judgment on whether to permit the user-desired transaction based on the contents of the received approval/rejection information; and
a step of permitting the user-desired transaction if the result of the permission/rejection judgment is affirmative.

16. A user terminal which can be used to carry out permission/rejection judgment on whether to permit a user-desired transaction, the user terminal comprising:
a receiving means which if a user desires a transaction, receives specific data containing acquired user image data obtained by acquiring the image of the user and the details of the user-desired transaction through a communication network;
a displaying means which displays the acquired user image data and the details of the transaction contained in the received specific data and further makes it possible for the user to input approval/rejection information on whether to approve the transaction; and
a transmitting means which when the approval/rejection information is inputted by the user, transmits the inputted approval/rejection information to a predetermined terminal device.

17. A computer program for building a user terminal which can be used to carry out permission/rejection judgment on whether to permit a user-desired transaction, the computer program causing a computer to execute:
a step in which if a user desires a transaction, the user terminal receives specific data containing acquired user image data obtained by acquiring the image of the user and the details of the user-desired transaction through a communication network;
a step in which the acquired user image data and the details of the transaction contained in the received specific data are displayed and further it is made possible for the user to input approval/rejection information on whether to approve the transaction; and
a step in which when the approval/rejection information is inputted by the user, the inputted approval/rejection information is transmitted to a predetermined terminal device.

18. A system for deciding whether to permit a user-desired transaction, the system comprising:
a first permission/rejection judging means which receives information for a first permission/rejection judgment on whether to permit a user-desired transaction;
a second permission/rejection judging means which receives information for carrying out a second permission/rejection judgment on whether to permit the user-desired transaction;
a permission/rejection judgment controlling means which determines whether the second permission/rejection judgment is required, and if the result is affirmative, causes the second permission/rejection judging means to carry out the second permission/rejection judgment; and
a permitting means which permits the user-desired transaction if the result of at least the second permission/rejection judgment is affirmative, and permits the transaction if the result of the first permission/rejection judgment is affirmative.

19. The system according to claim 18,
wherein the second permission/rejection judging means transmits data regarding the user-desired transaction to a predetermined information processing terminal through a communication network, and on receipt of the approval/rejection information from the predetermined information processing terminal, carries out second permission/rejection judgment on whether to permit the user-desired transaction.
